(19) United States
(12) Patent Application Publication
(10) Pub. No.: US 2024/0216839 A1
(43) Pub. Date: Jul. 4, 2024

(54) A PUMP-EQUIPPED SEPARATOR

(71) Applicant: Inheriting Earth Limited, St Philips (GB)

(72) Inventors: Reuben D'Orton-Gibson, Bristol (GB); Michael Lawrance-Owen, Bristol (GB); Reuben Kettle Aiers, Bristol (GB); Fergal Feeney, Bristol (GB); Adam Root, Bristol (GB)

(73) Assignee: Inheriting Earth Limited, St Philips, BS (GB)

(21) Appl. No.: 18/557,975

(22) PCT Filed: Apr. 29, 2022
(86) PCT No.: PCT/EP2022/061490

§ 371 Date: Oct. 30, 2023

(30) Foreign Application Priority Data
Apr. 30, 2021 (GB) 2106272.4
Nov. 12, 2021 (GB) 2116312.6

(51) Int. Cl. B01D 29/68; B01D 29/92; B01D 35/26; D06F 39/10

(52) U.S. Cl. CPC B01D 29/682; B01D 29/92; B01D 35/26; D06F 39/10; B01D 2201/084; B01D 2201/087

(57) ABSTRACT

A separator prevents microplastics from entering the environment by regenerating the pressure consumption of filters for removing microplastics in effluent from any source but in particular removing microfibers from domestic and commercial washing machine wastewater, industrial textile processing waste and roadside runoff. The separator separates microplastics from an effluent, and includes a chamber with an inlet and an outlet, a sieve structure forming a permeable barrier between the inlet and the outlet to filter the effluent, and a pump in fluid communication with the outlet of the chamber.

### FIELD OF THE INVENTION

The invention relates to preventing microplastics from entering the environment. In particular the invention is directed to regenerating the pressure consumption of filters for removing microplastics in effluent from any source but in particular removing microfibers from domestic and commercial washing machine wastewater, industrial textile processing waste and roadside runoff.

Microfibres are the most abundant form of microplastic pollution in rivers and oceans. Due to their microscopic scale, microfibers are eaten by organisms at all levels of the food chain, from plankton to top predators. Once ingested, plastics reduce feeding efficiency (false satiation) they may damage the gut of the animal and transfer harmful additives like PCBs, pesticides, flame-retardants to the animal that consumed it. Plastics consumed by animals low in the food chain also impact their predators, which consume numerous contaminated prey daily. The pervasiveness of microfibers in the food chain has naturally resulted in concern regarding their transfer to humans, and contamination has been observed in crustaceans, molluscs and fish species destined for human consumption.

Unlike microbeads, which are easily excluded from toiletries and cleaning products, microfibres are formed through damage to clothing. One third of all microplastics in the oceans come from washing of synthetic textiles. Synthetic fabrics derived from petrochemicals make up 65% of all textiles. Wear and tear caused by abrasive forces in washing machines result in the fragmentation of man-made textiles, forming hundreds of thousands of microfibres, less than 5 mm in length, which leak from homes and drainage networks into the ocean.

The vast impact of microplastics on marine ecosystems is starting to be understood. A 2019 study published in the ‘Science of the Total Environment’ journal found 49% of 150 fish samples from the North East Atlantic Ocean contained microplastics with evidence of this causing harm to brain, gills, and dorsal muscles. These microplastics are also passed onto people consuming fish at a rate of between 518-3078 microplastic items/year/capita.

The impact is not just being seen in fish stocks but also algae, the building blocks of life. A 2015 study published in the ‘Aquatic Toxicology’ journal demonstrated high concentrations of polystyrene particles reduced algal growth up to 45%. This should be of concern as microalgae are one of the world's largest producers of oxygen on this planet.

Wastewater treatment plants cannot remove the millions of fibres that pass through them every day. Currently, secondary level water treatment removes around 98% of the microplastics that pass through them. However, the small proportion that escapes still equates to tens of millions of fibres per treatment works per day.

Furthermore, wastewater treatment plants produce a “sewage sludge” and plastic microfibers are found on discharge when released into the natural environment when the sludge is spread on agricultural land, thus microfibers make their way into the food chain, waste to energy (which can destroy fibres but release harmful gasses) or discharged into rivers or the ocean.

Solutions are being developed to capture microfibers produced in domestic washing machines by filtering the effluent from these machines.

A typical domestic washing machine is shown in FIG. 1 in schematic form. The machine 100 includes a rotatable sealed drum unit 101 for receiving garments to be washed. The sealed drum unit 101 has a perforated cylindrical rotatable drum mounted inside a static waterproof shroud. Clean water is fed into the drum 101 via a cold-water inlet 102 connected to mains and under mains pressure of typically 1 bar. An electronic valve, under the control of a CPU 104, manages the water entering the drum 101. The inlet 102 is connected to a drawer 105 where a user can add liquid or powdered detergent. The drawer has an outlet that leads to the drum unit 101. The drum unit may include a heater under the control of the CPU to heat the water to the desired wash temperature, typically up to 90 degrees Celsius. The drum is rotatable by an electric motor 106 under the control of the CPU 104 at speeds of typically from 5 to 1600 rpm. The drum unit can be emptied via an outlet having an electronically operated drain valve 107 and a drain pump 108 both controlled by the CPU. The drain pump is rated with a given power to produce a known pressure at its output. The drain pump feeds into an outlet 109, which is connected, to the household or industrial drain and eventually the wastewater network.

FIG. 2a shows a typical domestic washing machine setup where a washing machine 201 sits on a floor 202 underneath a work surface 203. The waste output 204 of the washing machine is fed into an open soil pipe 205. The opening of the soil pipe is above the floor by a given height, typically 30-100 cm and it is open to prevent syphoning of all of the water out of the washing machine when it drains. The top of the soil pipe 206 is known as the waterline and the pump of the washing machine needs to be powerful enough to raise the waste to above this waterline in order to effectively drain it. When a washing machine initially fills, a quantity of water is required to fill the region below the drum before the drum itself fills, the drum being where the water is actually required for the wash process to occur. Typically, a washing machine is designed to retain a small reservoir of water between washes, so that no extra water is required for water to become available in the drum. This is advantageous because the first water to arrive in the drum contains the detergent as it is rinsed out of the drawer into the drum. Without the small reservoir of water, the detergent would be lost and the wash process would be ineffective.

In use, dirty laundry is placed in the drum, and a wash cycle initiated by a user. The CPU allows cold water to flow via the drawer to mix with detergent and then on into the drum, where the water is heated. The combined water, detergent and laundry is agitated by rotating the drum. During this process, dirt and grease is released into the water and fibres from the clothing too. If the clothing is synthetic, microfibers are typically released as the clothes rub against each other. The resulting effluent at the end of the wash cycle is a mixture of debris, dirt, grease and microfibers and potentially large objects such as coins or nails left in the clothing. This effluent is then drained and pumped out of the drum at a typical rate of 2 gallons per minute. Second or third rinse cycles with clean water may be performed, resulting in effluent with less concentrated contaminants.

Conventional washing machines have filters that are designed to stop pennies and buttons breaking the washing machine pump. The filtration required to stop microfibres is less than 50 micrometers (um), which is about the width of a human hair.

Microfibre separators are being developed that can be retrofitted externally to a washing machine, by connecting the output of the washing machine into a standalone separator unit and the output of the separator unit sent to the open soil pipe. However, the location of such a separator unit is limited to above the water line. If such a separator unit is located below the water-line, then it will not drain fully, which poses problems in emptying the unit because it will be full of contaminated waste water. It therefore needs to be located above the water line. However, fitting a separator unit above the water line can be problematic, as shown in FIG. 2b. The filter unit 207 shown in dotted lines needs to be located above the water line but the clearance between the work-surface 203 and the top of the soil pipe 206 is insufficient to allow this.

It is therefore an object of the invention to provide a separator unit that can be fitted in any location, including below the water line.

Another problem is that mesh filters clog up quickly and when this happens their effectiveness drops off considerably. This causes the pressure to drop and the flow rate to reduce, which can lead to damage to pumps and other elements of the system and flooding.

It is therefore a further object of the invention to provide a separator unit for separating microfibers from effluent that does not clog and that maintains an effective operating pressure over time.

### SUMMARY OF THE INVENTION

A separator is provided for separating solid material from a fluid, the separator comprising a chamber with an inlet and an outlet, a sieve structure forming a permeable barrier between the inlet and the outlet to filter the fluid, and a pump in fluid communication with the chamber, wherein the separator may further comprise a filter pressure regeneration apparatus for dislodging filtered material from the sieve structure, wherein the filter pressure regeneration apparatus comprises a conduit and a nozzle assembly having at least one cleaning jet directed towards the outlet side of the sieve structure and wherein the pump is arranged to recirculate the filtered fluid to the conduit of the filter pressure regeneration apparatus, wherein the sieve structure has a circular cross-section, and wherein a channel is formed between the chamber and the sieve structure such that in use the fluid is guided circumferentially around the sieve structure through the channel.

The at least one cleaning jet may be directed towards the outlet side of the sieve structure.

The pump may be a water pump arranged to also drain the separator or a separate pump may be provided to drain the separator.

A restriction may be provided in a conduit downstream from the pump, wherein the aperture of the restriction may be set to ensure that a preset amount of filtered fluid is recirculated into the filter pressure regeneration apparatus and an amount of the filtered fluid is drained.

An air vent may be provided in a conduit between the pump and the filter pressure regeneration apparatus to introduce air into the conduit.

The filter pressure regeneration apparatus may comprise a conduit and a nozzle assembly having at least one cleaning jet directed towards the outlet side of the sieve structure and wherein a second pump is arranged to recirculate the filtered effluent to the conduit of the filter pressure regeneration apparatus.

The separator may further comprise an air pump located between the pump and the filter pressure regeneration apparatus to introduce air into the conduit and to drain the separator.

The water pump may be a positive displacement pump or a centrifugal pump.

The filter pressure regeneration apparatus may comprise a conduit and a nozzle assembly having at least one cleaning nozzle directed towards the outlet side of the sieve structure.

The chamber may be cylindrical and the sieve structure may be a coaxial cylinder within the chamber and wherein a wall may be provided to one side of the inlet such that the effluent is guided around the sieve structure through a channel such that filtered microplastics dislodged by cleaning fluid from the at least one cleaning jet accumulates on the side of the wall away from the inlet.

A trap may be provided comprising an opening in the base of the channel to a sub-chamber, where the accumulating filtered microplastics can be collected.

The nozzle assembly may comprise a plurality of cleaning nozzles that are rotatable around the central axis of the sieve structure.

The nozzle assembly may be rotated by propulsion nozzles arranged to direct a stream of water having a vector that is tangential to the circumference of the sieve structure.

The chamber may have a closed top and bottom.

The structure may have an opening at the top to relieve pressure.

The separator may further comprise a filter pressure regeneration apparatus for dislodging filtered material from the sieve structure, wherein a sensor such as a fluid level detector is provided, and wherein the filter pressure regeneration apparatus is arranged to be activated in accordance with the output from the fluid level detector.

A reservoir may be provided below the chamber and the sensor is located in the reservoir.

The sensor may be a fluid level detector such as a float switch.

A bypass conduit may be provided between the inlet and the outlet to provide an alternative route for effluent in the event that the flow of fluid is impeded.

The bypass conduit may include a pressure-activated valve.

In an embodiment, a washing machine with a separator as described above is provided.

In an embodiment, a method of operating a separator of the type described above is provided, comprising the steps of, filtering fluid through a sieve structure, operating a pump to pressurise the filtered fluid.

The pump may be operated to drain the separator.

The pump may be operated to recirculate the filtered fluid to a pressure regeneration apparatus that is arranged to spray the filtered side of the sieve structure with wash fluid to dislodge debris from the unfiltered side of the sieve structure.

### BRIEF DESCRIPTION OF THE DRAWINGS

FIG. 1 shows a typical domestic washing machine.

FIG. 2a shows a washing machine under a counter.

FIG. 2b shows the location of a separator externally from a washing machine.

FIG. 3a shows a conventional separator.

FIG. 4 shows a cross section of a conventional filter assembly.

FIG. 5 shows a cross section of an embodiment having a drain pump.

FIG. 6 is a graph showing the efficacy of different types of filter assembly.

FIG. 7 shows a cross section of an embodiment having a single nozzle for regenerating the pressure consumption of the filter.

FIG. 8 shows a cross section of an embodiment having single nozzle for regenerating the pressure consumption of the filter with a combined recirculation and drain pump.

FIG. 8 shows a cross section of an embodiment having single nozzle for regenerating the pressure consumption of the filter with separate recirculation and drain pumps.

FIG. 10 shows a cross section of an embodiment having single nozzle for regenerating the pressure consumption of the filter with a recirculation pump and an air drain pump.

FIG. 11 shows a cross section of an embodiment having an array of nozzles for regenerating the pressure consumption of the filter.

FIG. 12a shows an embodiment having a cylindrical sieve structure and an array of fixed cleaning nozzles.

FIG. 12b shows another view of the embodiment of 12a.

FIG. 13a shows an embodiment having rotating cleaning nozzles.

FIG. 13b shows a detailed view of waste material being ejected from the unfiltered side of the sieve structure by spraying with a jet of fluid from the filtered side of the sieve structure.

FIG. 13c shows a detailed view of a water pellet being ejected from a nozzle.

FIG. 14a shows an alternative arrangement of cleaning nozzles.

FIG. 14b shows an alternative arrangement of cleaning nozzles.

FIG. 15a shows a propulsion nozzle assembly.

FIG. 15b shows a propulsion nozzle assembly in action.

FIG. 16a shows a perspective view of an embodiment of a separator.

FIG. 16b shows a cross sectional view of an embodiment of a separator.

FIG. 16c shows a cross sectional view of an embodiment of a separator.

FIG. 16d shows a cross sectional view of an embodiment of a separator.

FIG. 17 shows a cross sectional view of an embodiment of a separator having a recirculation pump for recirculating filtered effluent as wash fluid.

FIG. 18a shows a cross sectional view of an embodiment of a separator having a combined recirculation and drain pump for recirculating filtered effluent as wash fluid and for draining the separator.

FIG. 18b shows an alternative arrangement of pump and conduits.

FIG. 19 shows a cross sectional view of an embodiment of a separator having separate recirculation and drain pumps for recirculating filtered effluent as wash fluid and for draining the separator.

FIG. 20 shows a cross sectional view of an embodiment of a separator having a water pump for recirculation and an air pump for draining the separator.

FIG. 21a shows an embodiment having a float switch for detecting when there is water in a reservoir.

FIG. 121b shows an embodiment having a pressure sensor for detecting when there is water in a reservoir.

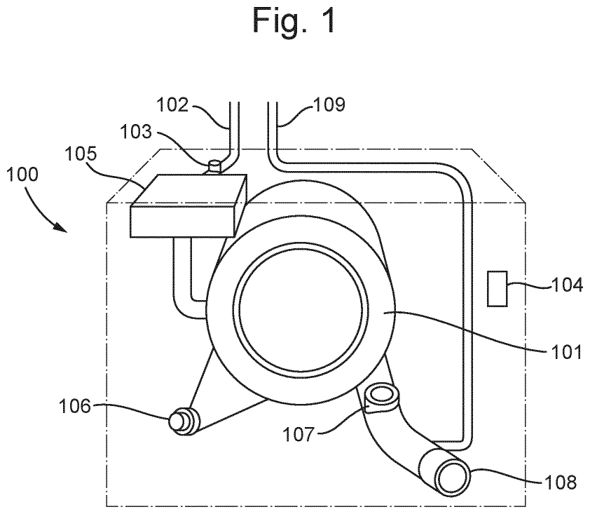

FIG. 22 shows an embodiment having a bypass system.

FIG. 23 shows a bypass system comprising a pressure-activated valve.

FIG. 24 shows a bypass system comprising an upstanding tube.

FIG. 25 shows a bypass system comprising a pair of upstanding tubes joined by an anti-syphon chamber.

FIG. 26 shows a bypass system comprising a Pitot tube.

FIG. 27 shows a bypass system comprising a Venturi.

FIG. 28a shows a washing machine equipped internally with an embodiment of the separator

FIG. 28b shows a washing machine retro-fitted externally with an embodiment of the separator.

### DETAILED DESCRIPTION OF THE PREFERRED EMBODIMENT

While the description that follows focuses on washing machines for clothes, it is to be understood that the teachings herein are not limited to use in washing machines as they are equally suited to other processing appliances, such as but not limited to driers, such as tumble driers, dyeing machines, cutting machines, recycling machines, dry cleaning machines and or any other domestic or commercial textile processing equipment. The teachings herein could also be used in other industries in which microparticles may be generated as a result of processing of items. References to washing machines herein are therefore to be understood as comprising any similar appliance of the types contemplated herein.

The separator described herein may be installed within the appliance itself during manufacture as shown in FIG. 28a, or retro-fitted externally to a washing machine or other appliance, as shown in FIG. 28b.

The separator system 2800 described above may be installed within a washing machine, as shown in FIG. 28a. The waste from the washing machine drum connects to the inlet 2807 of the separator 2800 and the outlet of the separator connects to the waste outlet 2809. A supply of fresh water 2806 for the regeneration apparatus is shown but if the recirculation system is used then this supply is unnecessary. A separator system 2808 may be located outside a washing machine, connected to the waste water outlet of the washing machine, as shown in FIG. 28b. The inlet 2809 supplies effluent into the separator 2808 and the outlet 2810 feeds into the soil pipe 2805. The embodiment shown is fitted with a drain pump to enable installation below the dotted water line in the figure, i.e. the top of the soil pipe. The embodiment shown also has a recirculation system therefore a separate supply of fresh water is not needed. The device may be connected to an electrical power supply (not shown) to operate the pump or pumps.

It will further be appreciated that the teachings herein are suited to any application that requires the removal of microplastics, including microfibers, from any effluent, including wastewater, within which such materials may be entrained. This also includes the runoff from roadside drains.

Effluent is understood to include wastewater from the sources mentioned above. It can also include the wastewater from Wastewater Treatment Plants. Effluent includes entrained dirt, detergent and micropollutants including microplastics, which include microfibers.

In a typical wash, the highest concentration of microfibers is in the range 5 mm to 150 um but shorter microfibers exist that are still harmful in the environment. If it were required to remove 99% of microfibers of all sizes down to 50 um in length, a mesh with apertures of 50 um would theoretically be able to achieve this. In practice however, such a mesh placed directly in the stream of effluent will clog almost immediately and the filter will become inoperable. This will create a rise in pressure consumption in the outlet and potentially damage the pump.

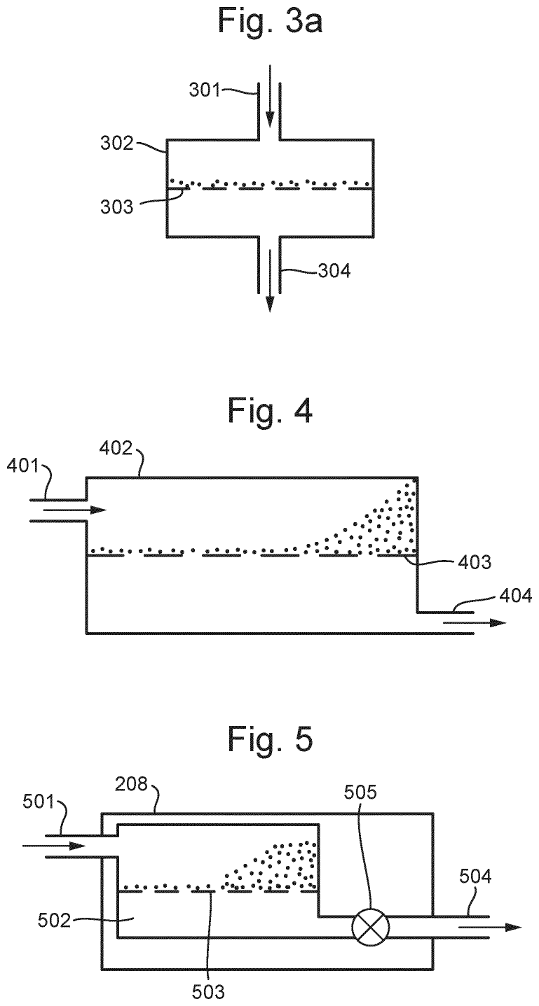

A conventional separator or filter arrangement is shown in FIG. 3. An inlet 301 directs effluent into a filter housing 302, within which a sieve structure 303 is supported. The sieve structure could be a mesh or other perforated material where the mesh opening size is selected to trap particles of a required dimension. Filtered effluent passes through the sieve structure 303 to an outlet 304. The filtered waste accumulates on what is called the unfiltered side of the sieve structure, while the outlet side of the sieve structure is called the filtered side. Filter efficacy is its effectiveness at removing debris of a given size range while maintaining an acceptable flow rate and is closely related to the filter's pressure consumption. The sieve structure shown in FIG. 3 will become blinded over by filtered debris rapidly, so that its pressure consumption will increase, and its efficacy decrease.

FIG. 4 shows an alternative arrangement where the effluent inlet 401 is located at one end of a channel 402, where the sieve structure 403 forms a wall of the channel 402. In this way the incoming effluent will urge the filtered waste towards the other end of the channel.

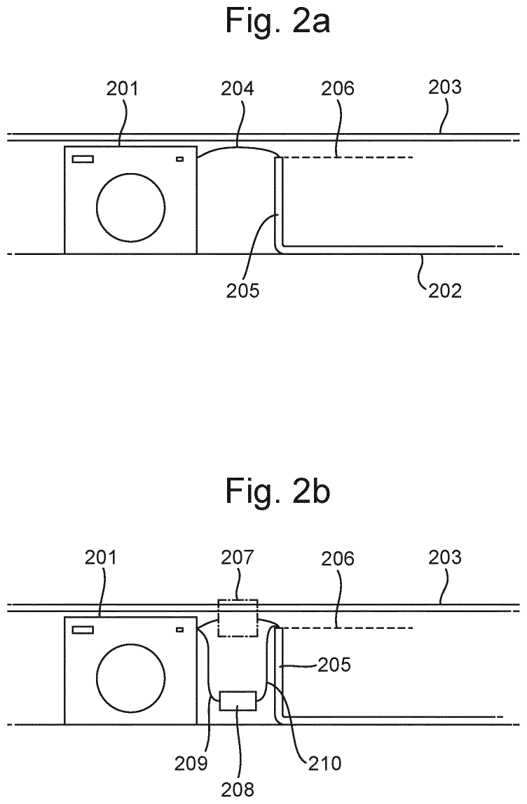

FIG. 5 is an embodiment of the invention, which is a separator unit 208 that can be fitted below the water line, as shown in FIG. 2b. The separator unit comprises an inlet 501, a housing 502 and a sieve structure 503 and an outlet 504. The outlet is fitted with a pump 505 which can drain the filter unit. Without the pump, effluent will sit in the pipe between the top of the washing machine outlet and the water line, if the separator unit is fitted below the water-line. With the pump 505 fitted, all of the effluent sitting in the washing machine outlet pipeline 209 on the unfiltered side of the separator can be pulled through the separator and all of the filtered effluent on the outlet side can be pushed up the separator outlet pipeline 210 on the filtered side of the separator and into the soil pipe 205. The pump can be a positive displacement pump or a centrifugal pump or any other type of pump.

The provision of a pump enables greater flexibility in the location of the filter. This is advantageous to users who may be limited in where they could locate the filter.

In use, as the effluent fills the chamber, particles are filtered out and remain stuck to the outside of the mesh, increasing the power consumption and lowering the efficacy of the filter as the mesh starts to clog.

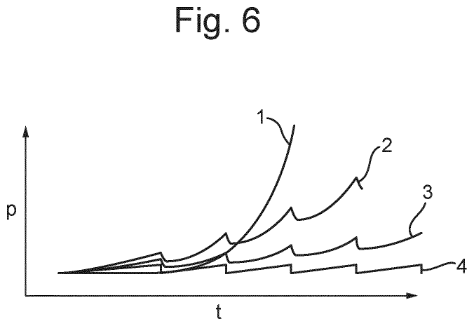

Curve 1 in FIG. 6 is a measure of the effectiveness of the arrangement shown in FIG. 5, given a constant flow of dirty water, with a consistent contamination level. The y-axis represents the fluid pressure; P, at the inlet 201 and it can be seen to rise gradually, then exponentially as the mesh becomes blinded over with filtrate.

In practice, the flow of effluent from a washing machine is not constant over time because a limited amount of water is used in each wash cycle. Curve 2 in FIG. 6 shows how the inlet pressure varies over time where the flow of effluent stops, drains through the device and then starts again. Reductions in the pressure can be seen, as the flow stops and debris previously held against the mesh by the pressure of the flow falls away, revealing pores that allow fluid to flow through again, until they become re-blocked in the next cycle. Curve 2 demonstrates that the pressure consumption required by the conventional device increases through use, so the inlet pressure required to filter effluent eventually becomes greater than the pump is able to provide.

It is necessary to open this device and clean the mesh by hand to return its pressure consumption back to a level for it to operate effectively, i.e. to regenerate its pressure consumption. This is a tedious and messy process. For some filter types, regeneration is not possible, for example if the filter is a cartridge type filter. These filters require the user to remove and replace them regularly which provides a worse user experience and results in wastage from consumable parts. The present invention therefore seeks to overcome the problem of regenerating the pressure consumption of mesh filters used for separating microplastics from a flow of effluent.

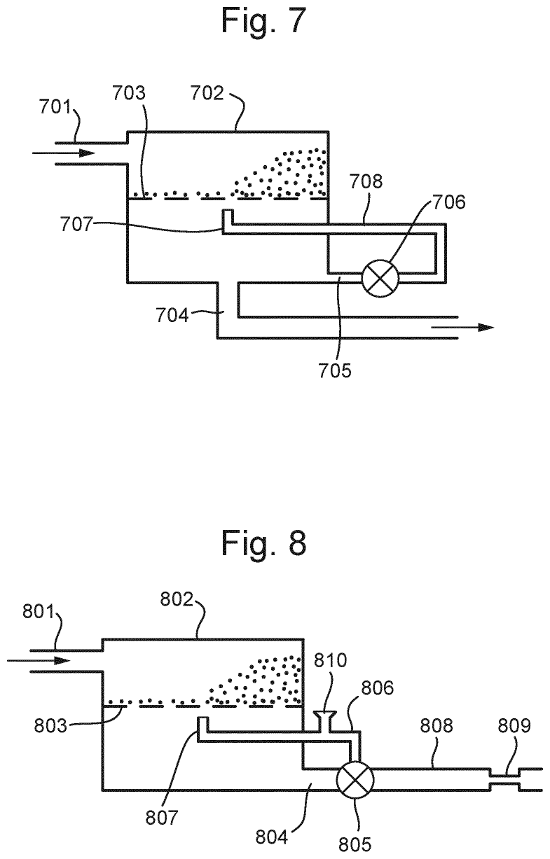

FIG. 7 shows an embodiment of the invention for separating microplastics from an effluent that regenerates the pressure consumption of a filter, comprising an effluent inlet 701 feeding a channel bounded by a filter housing 702 and a sieve structure 703. The filtered effluent exits from the separator via an outlet 704. A cleaning nozzle 707 is provided that is arranged to direct a cleaning jet of wash fluid towards the filtered side of the sieve structure 703. The cleaning nozzle 707 is connected by conduit 708 to a supply of wash fluid. The cleaning nozzle is periodically activated to dislodge filtered material from the unfiltered side of the sieve structure, which allows more effluent to be filtered out and thus regenerate the pressure consumption. As the waste material is dislodged, the flow of effluent carries it further away from the inlet towards the far end of the channel. In this embodiment the supply of wash fluid is the filtered effluent itself. A conduit 705 channels filtered effluent to a pump 706 which supplies pressurised wash fluid to the cleaning nozzle 707. This unit could not be fitted below the waterline.

FIG. 8 is a further embodiment where filter pressure is regenerated and the separator unit can be fitted below the waterline. A pump 805 is provided to drain the unit and to supply pressurised wash fluid to a cleaning nozzle 807. The separator unit comprises an inlet 801 into a housing 802 that supports a mesh filter 803. The outlet 804 of the unit is connected to pump 805. The pump is arranged to direct filtered effluent into a conduit 806 that provides pressurised wash fluid to the cleaning nozzle and also to empty the separator via outlet 808.

The volume of filtered effluent to be emptied from the washing machine when the filter is in operation is much greater than the volume of filtered effluent required for the cleaning nozzle. Therefore a restriction 809 in the outlet 808 is required to provide enough resistance to the flow through the outlet to encourage filtered effluent into the wash fluid conduit 806.

Optionally an air inlet 810 may be provided in the wash fluid conduit 806 to introduce air into the wash fluid. This can increase the effectiveness of the wash fluid in dislodging debris from the sieve structure.

It may be advantageous to be able to control the drainage of a separator unit and the pressure regeneration separately. FIG. 9 shows an embodiment that allows this by the provision of two pumps; a drainage pump 905 and a recirculation pump 908. The separator unit has an inlet 901 into a housing 902 that supports a sieve structure 903 that separates the inlet 901 from the outlet 904. The outlet 904 has a conduit that leads to the drainage pump 905. Also on the filtered side of the sieve structure is a wash fluid conduit 907 that leads to a wash fluid pump 908 and on to a further wash fluid conduit 909 that feeds the cleaning nozzle 910. The drainage pump 905 may be a positive displacement pump or a centrifugal pump that operates at around 0.1 Bar 10 litres per minute, but could be in the range up to 1 bar and 15 litres per minute. The recirculation pump 1408 operates at around 0.3 Bar and 5 litres per minute, but could be in the range up to 5 bar and 10 litres per minute.

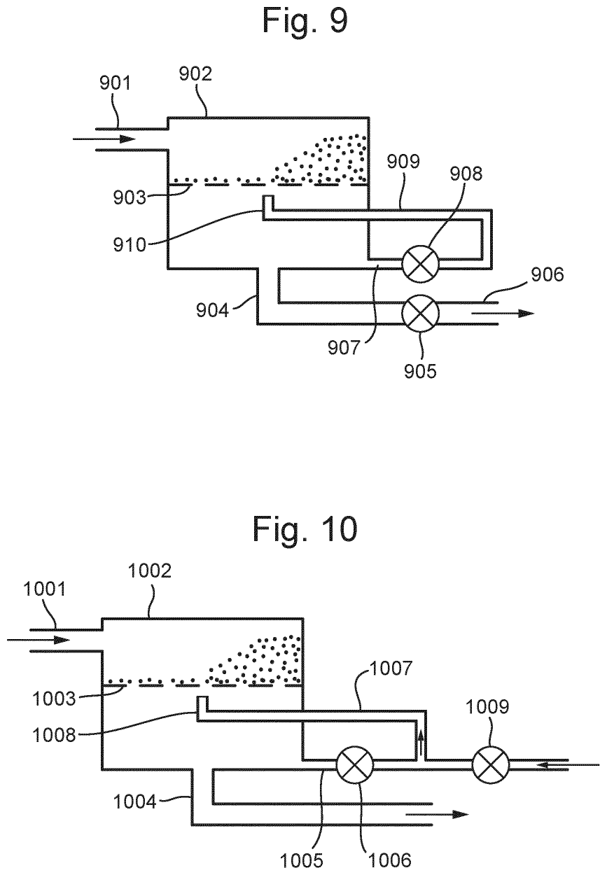

FIG. 10 shows an alternative embodiment of a separator unit where an air pump is used to assist with regeneration and drainage. An inlet 1001 is provided into a housing 1002 that supports a sieve structure 1003 that separates the inlet 1001 from an outlet 1004. A conduit leads to a pump 1006 that pumps filtered effluent into a further conduit 1007 that feeds wash fluid to a cleaning nozzle 1008. An air pump is connected into the further conduit 1007 to pump air into the wash fluid system. Air enhances the cleaning effect of the wash fluid jet emanating from the cleaning nozzle 1008. The air pump can also be operated to push any remaining fluid in the pipe connected to the outlet 1004 up to the waterline, which enables this embodiment to be mounted below the water-line. A one-way valve would need to be provided at the inlet (not shown) to prevent fluid from being pushed back into the washing machine.

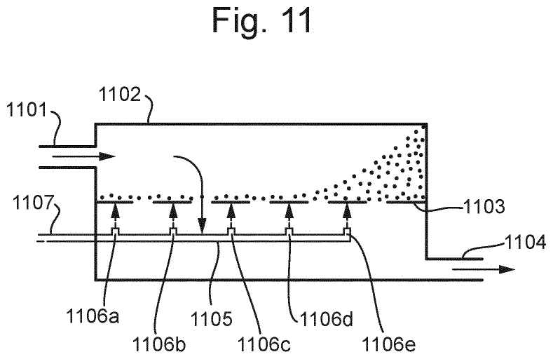

The pressure regenerating effect can be enhanced by a filter pressure regeneration system. This system comprises a nozzle assembly having an array of cleaning nozzles. FIG. 11 shows an embodiment for separating microplastics from an effluent, comprising an effluent inlet 1101 feeding a channel bounded by a filter housing 1102 and a sieve structure 1103. The filtered effluent exits from the separator via an outlet 1104. The nozzle assembly 1105 comprises a plurality of cleaning jets 1105a, b, c, d, e fed with wash fluid by conduit 1107. The cleaning jets are periodically activated to dislodge filtered material from the unfiltered side of the sieve structure, which allows more effluent to be filtered out and thus regenerate the pressure consumption. As the waste material is dislodged, the flow of effluent carries it further away from the inlet towards the far end of the channel.

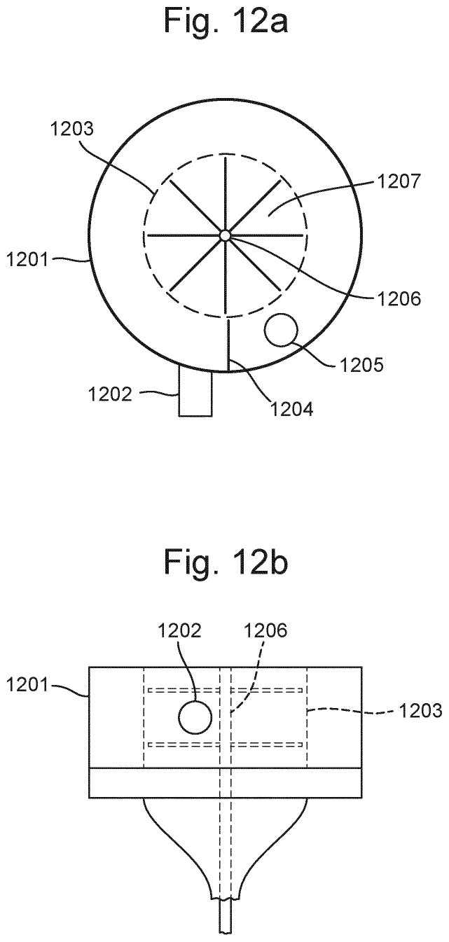

FIGS. 12a and 12b show an embodiment of the invention for separating microplastics from an effluent that regenerates the pressure consumption of a filter back to the level, or close to the level, of when it was new. A cylindrical chamber 1201 is provided having an inlet 1202 and a central cylindrical sieve structure 1203. A wall 1204 is provided to one side of the inlet that serves as a baffle to allow effluent to only flow one way when it enters the chamber and to allow filtered debris to collect in a specified location in the chamber. The inner wall of the chamber 1201, the outer wall of the sieve structure 1203 and wall 1204, define a channel through which unfiltered effluent flows around to the other side of the wall 1204 where it can accumulate. An aperture 1205 is provided through which the filtered material can pass and be trapped. A filter pressure regeneration system is provided comprising a wash fluid conduit 1206 that supplies wash fluid to an array of cleaning nozzles 1207 that project radially outwards from the conduit 1206 and are arranged to direct wash fluid perpendicularly at the filtered side of the sieve structure 1203 to dislodge material that accumulates against the unfiltered side of the sieve structure. As material is dislodged it is swept by the flow of effluent towards the end of the channel, through the aperture 1205 and into the trap. The jets of wash fluid can be operated continuously or periodically. The wash fluid is pressurised and forced through the cleaning nozzles so that the jets of wash fluid emanating from the cleaning nozzles have enough power to dislodge material, against the flow of the fluid component of the effluent passing through the sieve structure. The wash fluid could be clean mains water and the pressure provided by mains water pressure. A pump could also be used to pump clean water or another fluid from another source or recirculate the filtered water. If the wash fluid is pressurised by a pump, then the power consumption of the pump is a design consideration; minimising this power consumption is preferred to reduce the costs of the pump itself and its operating cost.

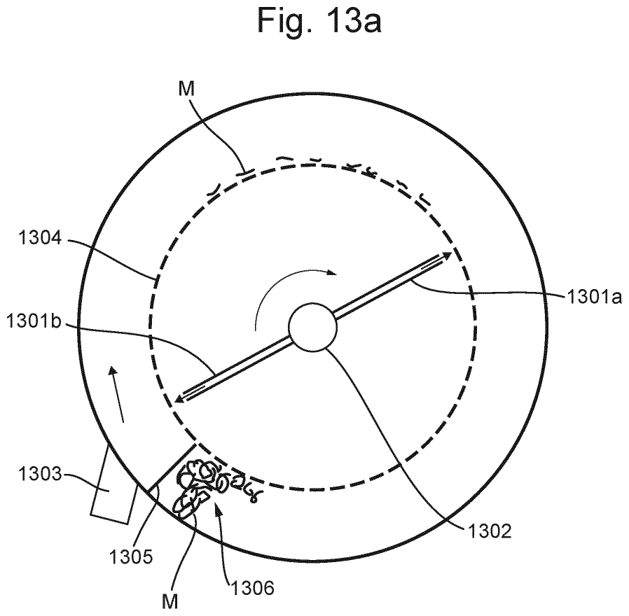

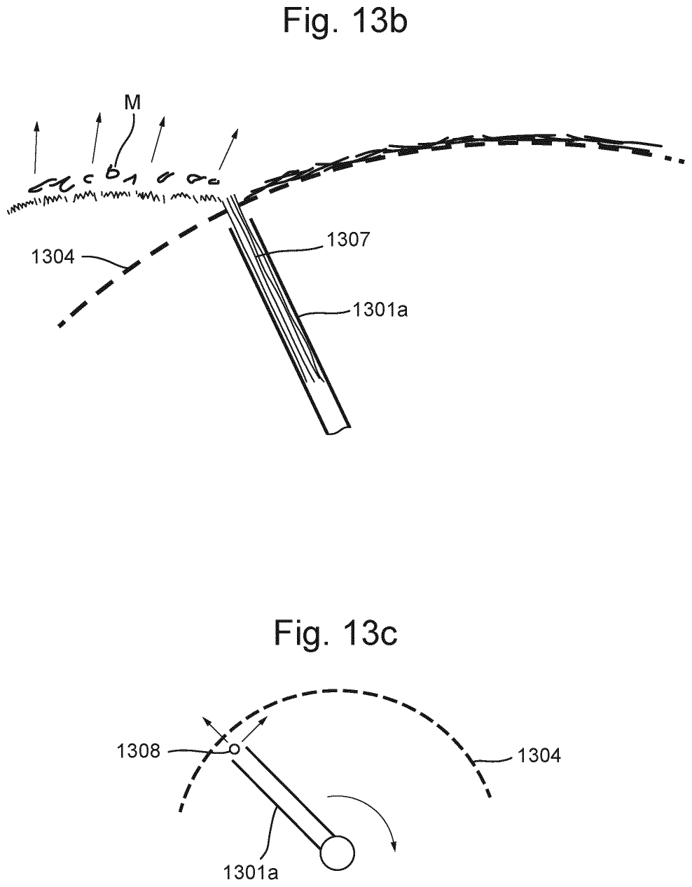

FIG. 13a shows an embodiment having a filter pressure regeneration system comprising a nozzle assembly that has two rotatable opposing cleaning nozzles 1301a, b extending radially from a central conduit 1302. The central conduit 1302 feeds the cleaning nozzles with pressurised wash fluid. Effluent enters the separator via inlet 1303 and passes around the channel formed by the outer wall of the chamber and the sieve structure 1304 around to the wall 1305 where filtered material M accumulates in the trap 1306. The cleaning nozzles 1301a, b are aligned perpendicularly to the sieve structure 1304. The cleaning nozzles can be rotated by a motor (not shown) or other means. In FIG. 13a, the cleaning nozzles are rotated in the direction of flow of the effluent. FIG. 13b shows a detailed view of the waste material M being ejected from the unfiltered side of the sieve structure 1304 by a jet of wash fluid 1307 emanating from the cleaning nozzle 1301a. By having a reduced number of rotating cleaning nozzles, the same coverage of the jet of wash fluid against the sieve structure can be achieved as with the array of fixed cleaning nozzles shown in FIG. 12a, but with less power required of the wash fluid pump. The cleaning nozzles could also be directed downwards to urge the ejected material down towards the trap. This arrangement is beneficial as the diameter of the sieve structure can be increased, and thus the surface area of the mesh, without the need for additional cleaning nozzles.

The wash fluid could be water or it could be a mixture of air and water. FIG. 13c shows a jet of cleaning fluid that includes water and air, where a pellet of water 1308 is seen being ejected from the cleaning nozzle 1301a. This increases the speed and ejection effect of the wash fluid.

In another embodiment, the nozzle assembly may be attached to a motor that has a shaft, on which an impeller is attached that rests in the reservoir. The motor simultaneously spins the spinner and the impeller. The impeller drains the water from the reservoir. The outlet has a recirculation channel as well as a drainage channel and the flow of water is fed through both, to drain the separator and to spray the filtered side of the sieve structure with filtered effluent.

The cleaning nozzles of the filter pressure regeneration system can be constructed so that a component of the pressurised wash fluid is tangential to the filtered side of the sieve structure. The end of the cleaning nozzles could be angled in the direction of flow of the effluent. This has the effect of ejecting the filtered material further out into the flow of effluent where it can be swept further along towards a trap before it re-attaches to the sieve structure under the action of the flow of effluent through the sieve structure. The nozzle assembly could be rotated in the direction of flow of the effluent or against the flow of effluent.

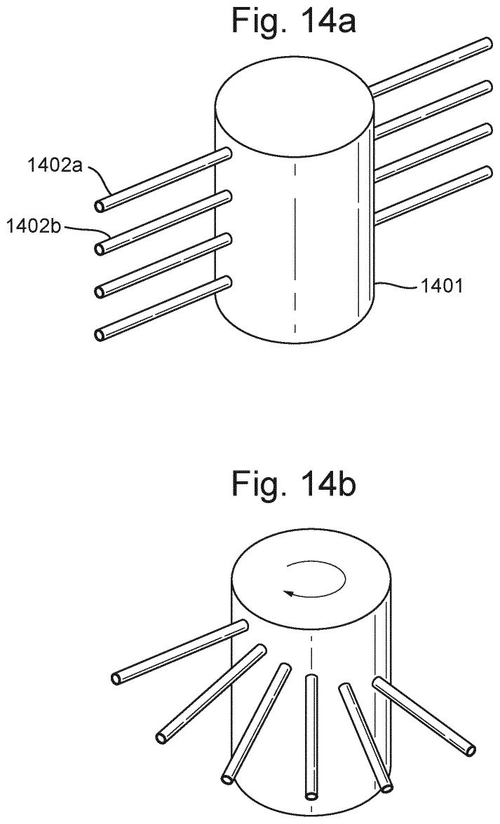

FIG. 14a shows an alternative arrangement of a nozzle assembly for the filter pressure regeneration system. A central hub 1401 supports an array of cleaning nozzles 1402a, b etc that extend radially from the hub 1401. The hub includes a conduit to feed pressurised wash fluid to the cleaning nozzles. The cleaning nozzles are arranged as a stack of four directly above each other and a matching stack directly opposite on the hub. This arrangement ensures that the entire width of the sieve structure is cleaned in each sweep of the nozzle assembly.

FIG. 14b shows a nozzle assembly where the array of cleaning nozzles are arranged in a helix configuration around a central hub. This encourages the ejected filtered material downwards in the flow of effluent and to reach the trap more quickly.

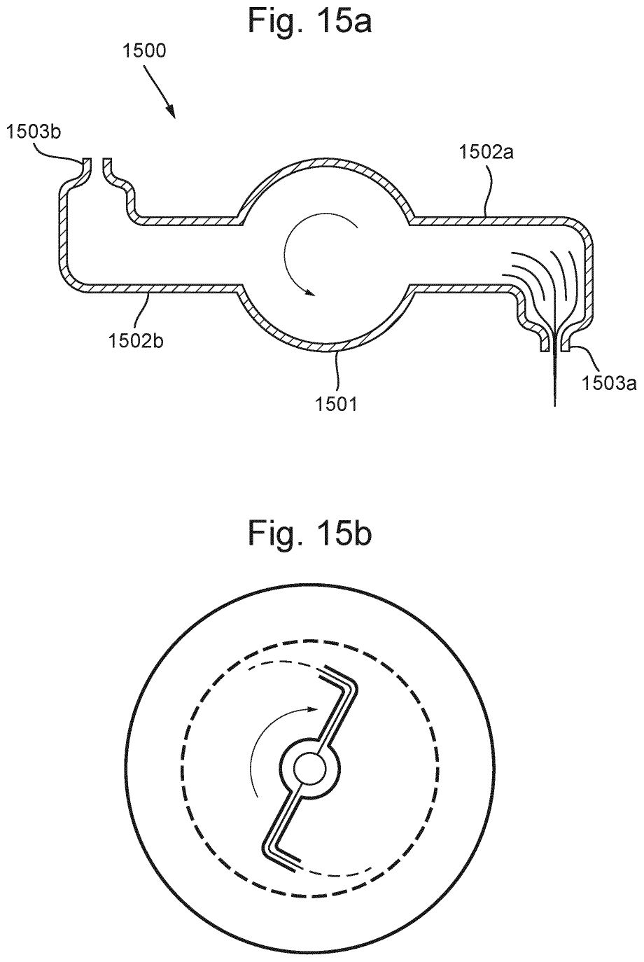

FIG. 15a shows a nozzle assembly rotation unit 1500 for propelling the nozzle assembly of the filter pressure regeneration system. The nozzle assembly rotation unit 1500 is fixed to the cleaning nozzles. The rotation unit comprises a central hub 1501 that acts as a conduit for propulsion fluid. The propulsion fluid and the wash fluid could be the same fluid, where the wash fluid conduit and rotation unit hub are connected. The rotation unit 1500 has radially extending arms 1502a, b that terminate in propulsion nozzles 1503a, b that are directed perpendicularly to the arms. Fluid exiting the propulsion nozzles is directed tangentially to the axis of the hub, causing the rotation unit 1500 to rotate and thus rotate the nozzle assembly that is fixed to it.

FIG. 15b shows a nozzle assembly rotation unit 1500 in action.

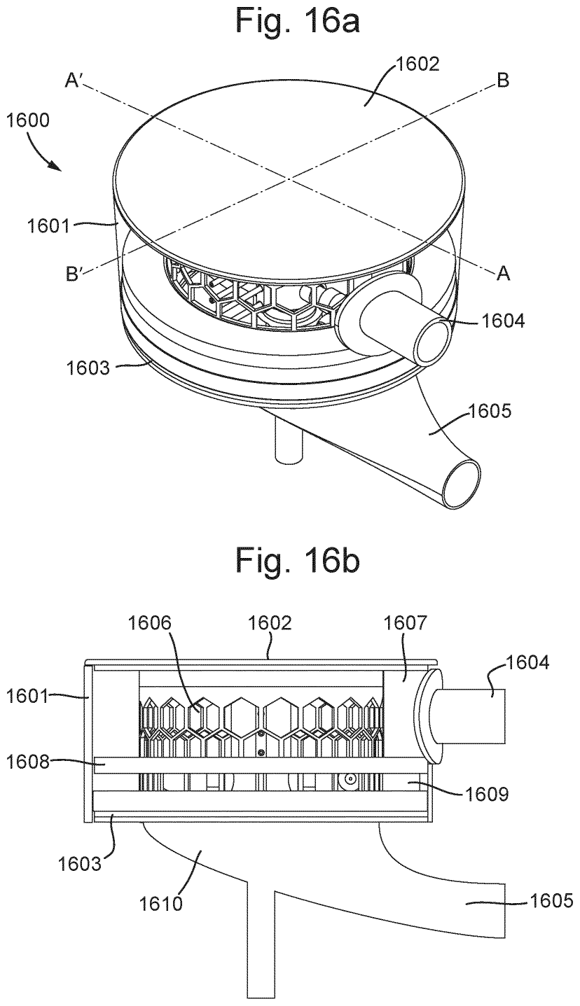

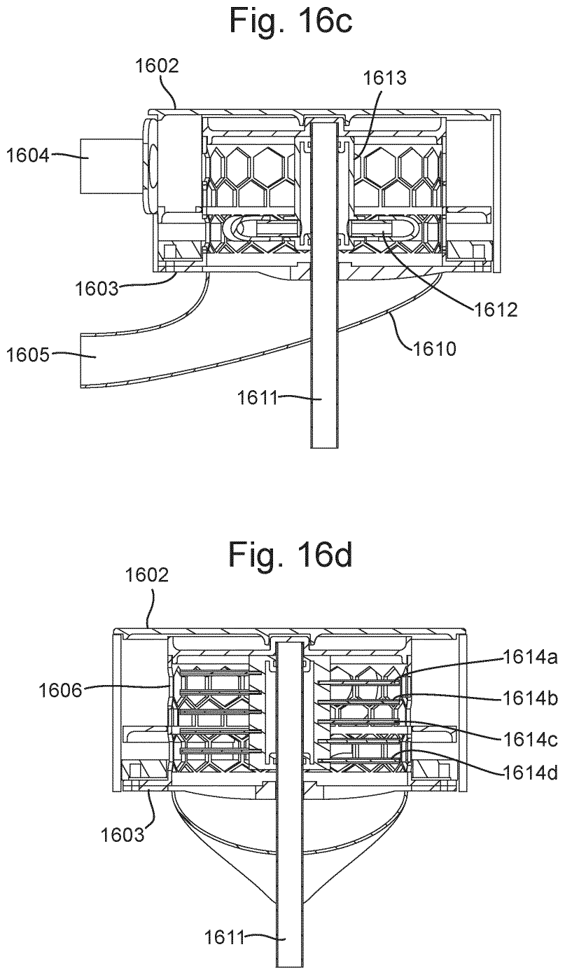

FIG. 16a shows an embodiment of a separator unit that includes a filter pressure regeneration system. The separator unit 1600 comprises an outer cylindrical wall 1601. In this embodiment the outer wall is transparent so that a user can see when the separator is operational and can also see the accumulated filtered waste. The separator unit 1600 has a circular cap 1602 and base 1603. An inlet 1604 is provided in the wall 1601. An outlet 1605 is provided in the base 1603.

FIG. 16b shows a cross section of the separator unit 1600. A cylindrical sieve structure is provided coaxially with the outer wall 1601. The sieve structure extends between the cap 1602 and the base 1603 and provides a seal beyond which unfiltered effluent cannot pass. The sieve structure comprises an open support scaffold to which is fixed a mesh of aperture 25 micrometers. Mesh sizes in the range 5-75 micrometers are also suitable. The mesh separates the solid material from the liquid component of the effluent. An interior dividing wall 1607 creates a channel for the effluent to flow around the sieve structure, starting at the inlet 1604. The chamber is divided horizontally into two parts by a partition 1608. The partition 1608 has an opening on the other side of the interior dividing wall 1607. The combination of the opening and the lower part of the chamber beneath the partition 1608 provide a trap 1609 within which waste material can accumulate. The outlet 1605 is connected to a scoop 1610 that collects filtered effluent that passes through the mesh.

FIG. 16c is a cross section of the separator unit 1600 taken along line A-A′ in FIG. 16a, where components of the filter pressure regeneration system are shown. A central vertical conduit 1611 provides wash fluid to the nozzle assembly. The nozzle assembly includes propulsion nozzles 1612 mounted on a rotatable hub 1613.

FIG. 16d is a cross section of the separator unit 1600 taken along line B-B′ in FIG. 16a, where components of the filter pressure regeneration system are shown. The nozzle assembly includes cleaning nozzles 1614a to d mounted on the rotatable hub 1613. The cleaning nozzles extend radially out from the hub to be proximal to the filtered side of the sieve structure.

The separator unit is around 15 cm in diameter. However, it will be appreciated that larger or smaller diameters could be selected depending on the application. The size of the unit is selected on the flow rate of effluent to be filtered. A separator diameter of 15 cm is sufficient to process the effluent from a domestic washing machine flowing at a rate of 10 litres per minute.

The open area of the mesh that enables the passage of water at a given flowrate can be adjusted by changing either the surface area of the mesh or the mesh aperture. The mesh aperture effects the efficiency, so a smaller mesh aperture is generally preferable to provide greater efficiency. The mesh surface area is a function of the height and diameter, therefore a given area can be matched by increasing the height if the diameter is reduced, and visa versa. All variables can be adjusted to meet product packaging and efficiency specification requirements.

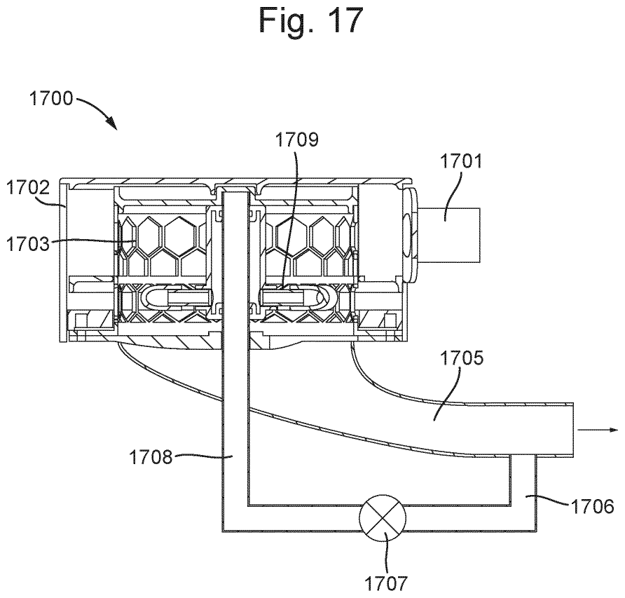

FIGS. 17 to 20 show how the pump-assisted embodiments of FIGS. 7 to 9 can be applied to a separator unit with a complex pressure regeneration system. A separator unit 1770 has an inlet, a cylindrical housing and a sieve structure 1703. An outlet 1705 collects filtered effluent. A portion of the filtered effluent is diverted into conduit 1706, where it is pressurised by pump 1707 and directed into the central vertical conduit 1708 that provides wash fluid to the nozzle assembly 1709. This embodiment is not suitable for location below the waterline because the outlet is not pumped, it must drain by gravity.

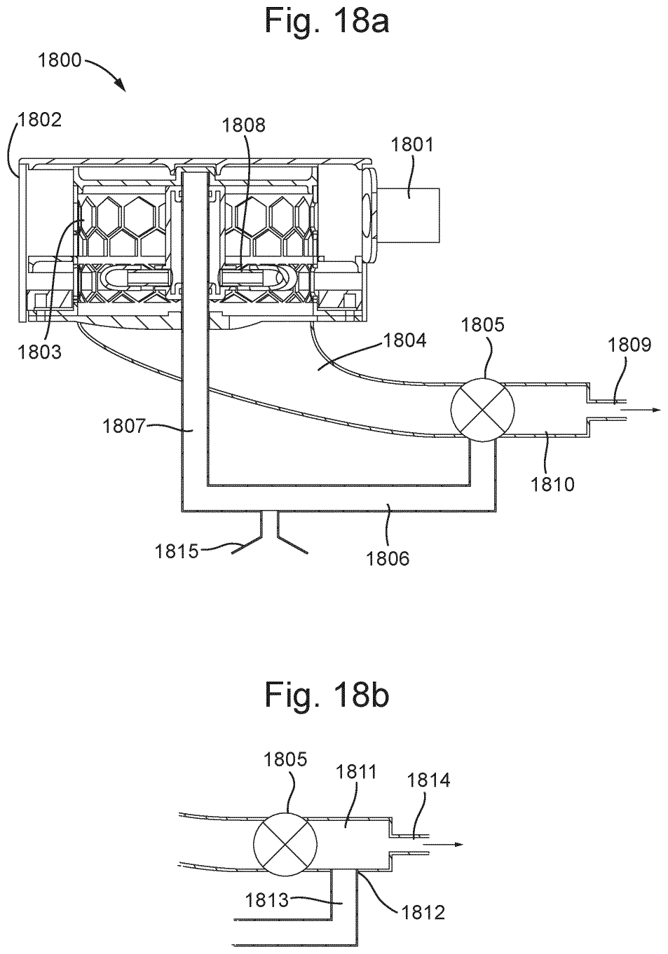

FIG. 18a shows an embodiment that is suitable for location below the waterline and that also recirculates some of the filtered wastewater to regenerate the filter pressure. The separator unit 1800 has an inlet 1801, housing 1802, sieve structure 1803 and outlet 1804. All of the filtered effluent from the outlet 1804 is pumped out via pump 1805. The pump 1805 is arranged to divert a portion of the filtered effluent back via conduit 1806 to the central vertical conduit 1807 that provides wash fluid to the nozzle assembly 1808. A restriction 1809 is provided in the pump outlet pipe 1810 to ensure that an adequate volume of fluid is re-circulated to the pressure regeneration system. Alternatively, the pump 1805 may have a single outlet as shown in FIG. 18b and a junction 1812 that diverts some filtered effluent to conduit 1813 to be re-circulated into the pressure regeneration system and the rest to the soil pipe. A restriction 1814 is provided to determine the proportion of filtered effluent that is re-circulated. An air inlet 1815 in the conduit 1806 may be provided that allows air into the pressure regeneration system to enhance the cleaning effect of the jet of cleaning fluid against the filtered side of the sieve structure.

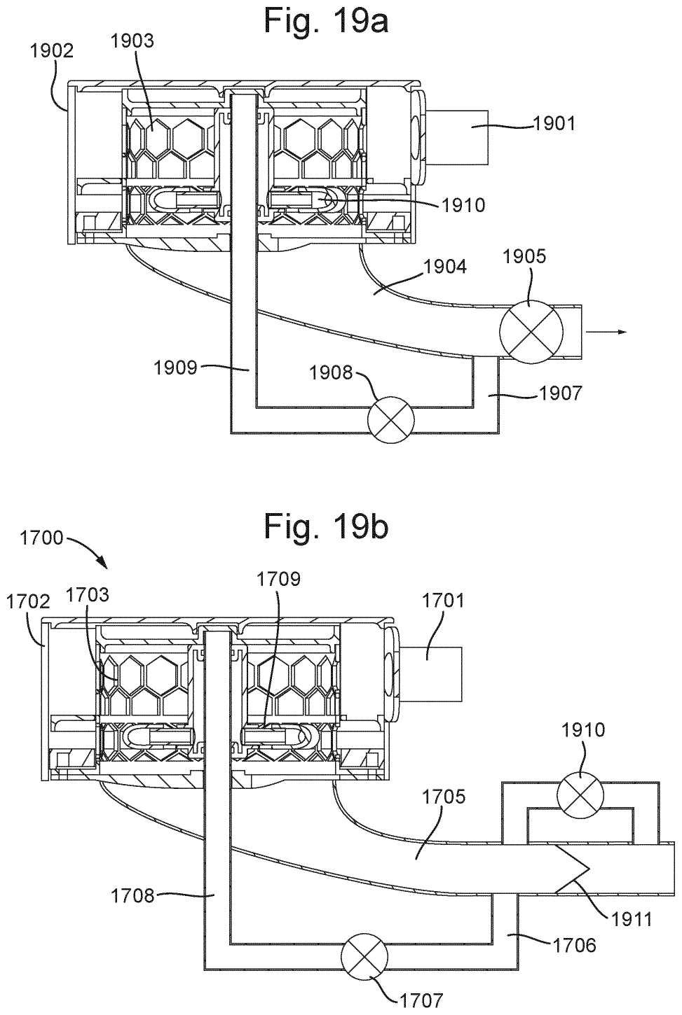

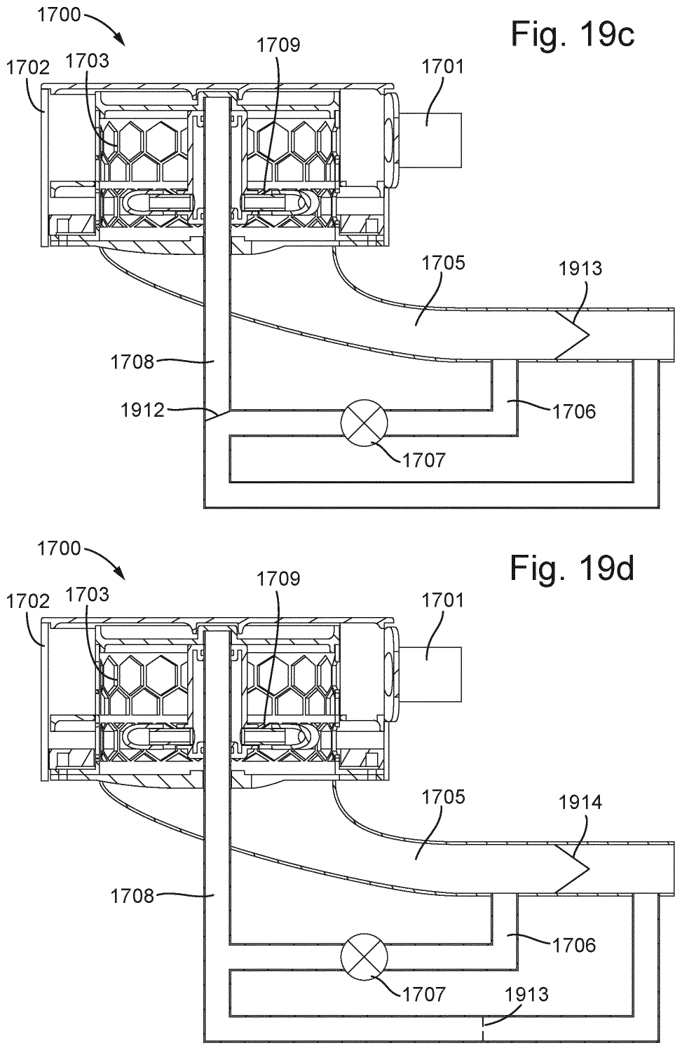

It may be advantageous to be able to control the drainage of a separator unit and the pressure regeneration separately. FIG. 19 shows an embodiment that allows this by the provision of two pumps; a drainage pump 1905 and a recirculation pump 1908. The separator unit has an inlet 1901 into a housing 1902 that supports a sieve structure 1903 that separates the inlet 1901 from the outlet 1904. The outlet 1904 has a conduit that leads to the drainage pump 1905. Also on the filtered side of the sieve structure is a wash fluid conduit 1907 that leads to a wash fluid pump 1908 and on to a further wash fluid conduit 1909 that feeds the cleaning nozzle assembly 1910. The drainage pump 1905 may be a positive displacement pump or a centrifugal pump that operates at around 0.1 Bar 10 litres per minute. The recirculation pump 1908 operates at around 0.3 Bar and 5 litres per minute.

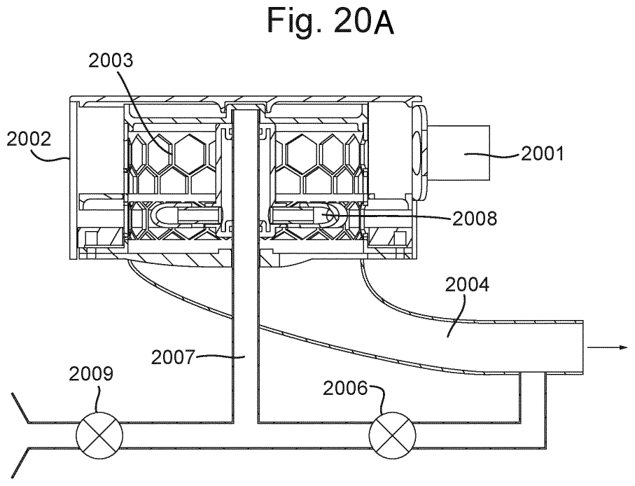

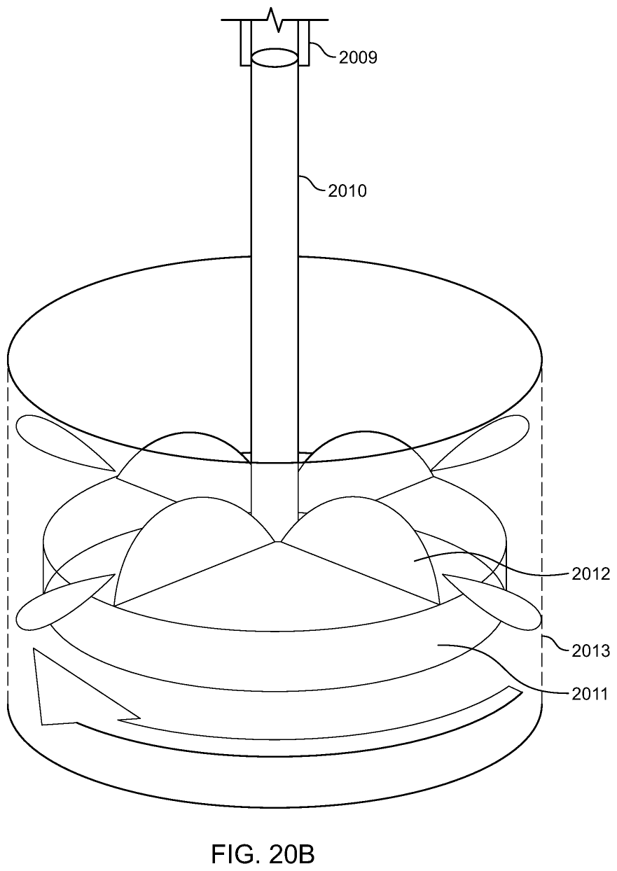

FIG. 20 shows an alternative embodiment of a separator unit where an air pump is used to assist with regeneration and drainage. An inlet 2001 is provided into a housing 2002 that supports a sieve structure 2003 that separates the inlet 2001 from an outlet 2004. A conduit leads to a pump 2006 that pumps filtered effluent into a further conduit 2007 that feeds wash fluid to a cleaning nozzle assembly 2008. An air pump 2009 is connected into the further conduit 2007 to pump air into the wash fluid system. Air enhances the cleaning effect of the wash fluid jet emanating from the cleaning nozzle 2008. The air pump can also be operated to push any remaining fluid in the pipe connected to the outlet 2004 up to the waterline, which enables this embodiment to be mounted below the waterline. A one-way valve would need to be provided at the inlet (not shown) to prevent fluid from being pushed back into the washing machine.

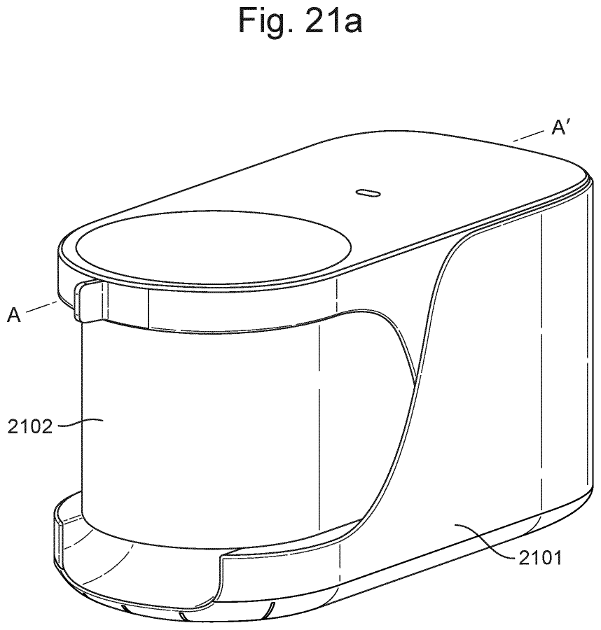

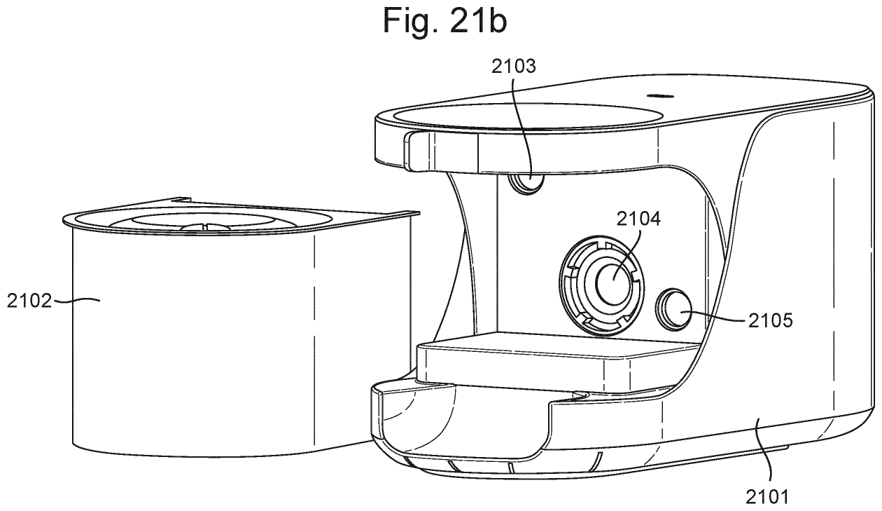

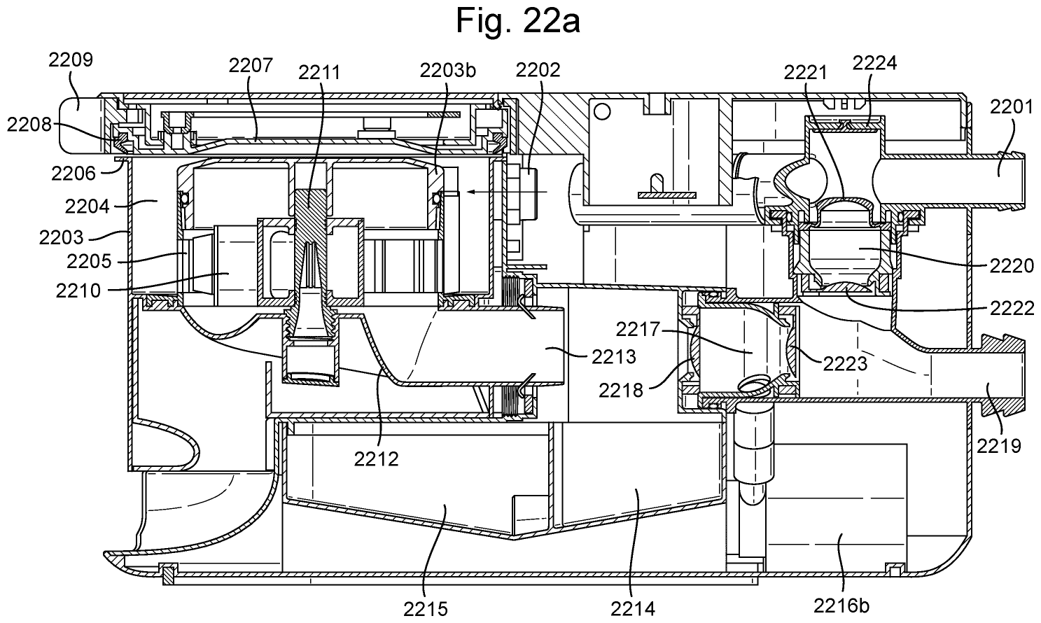

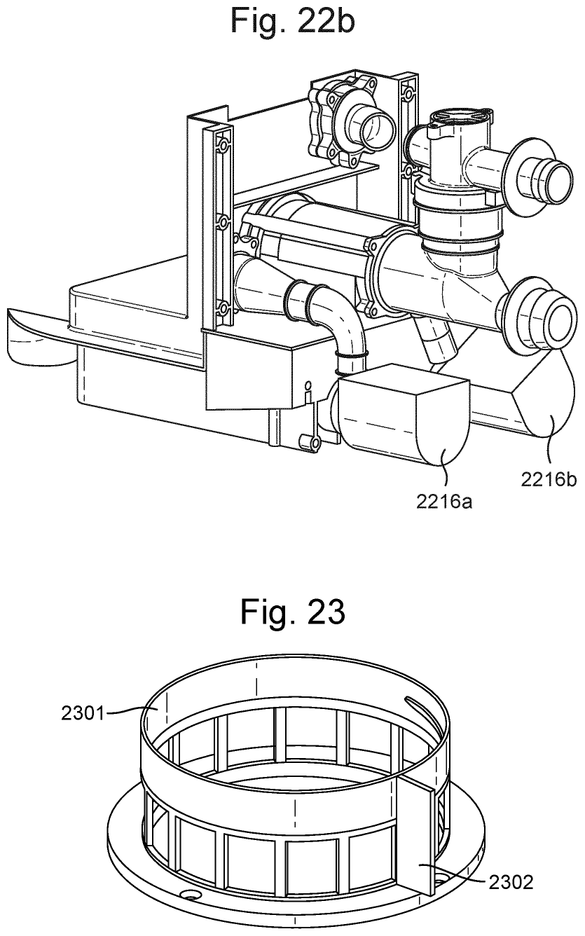

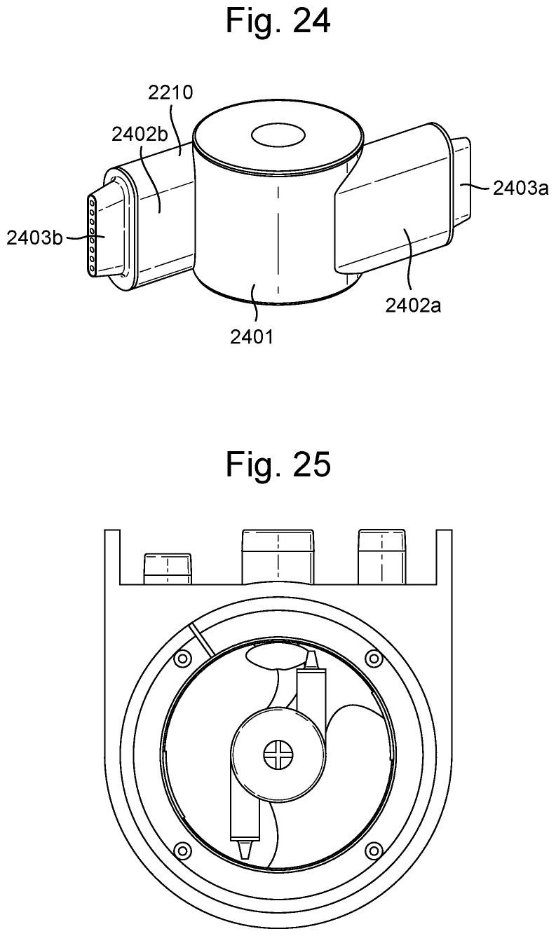

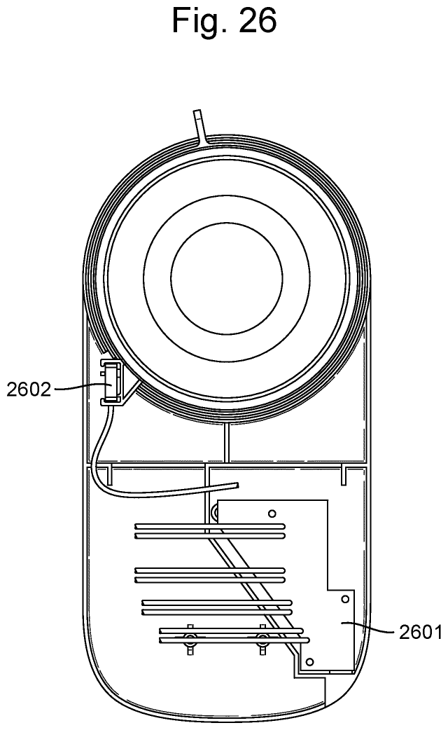

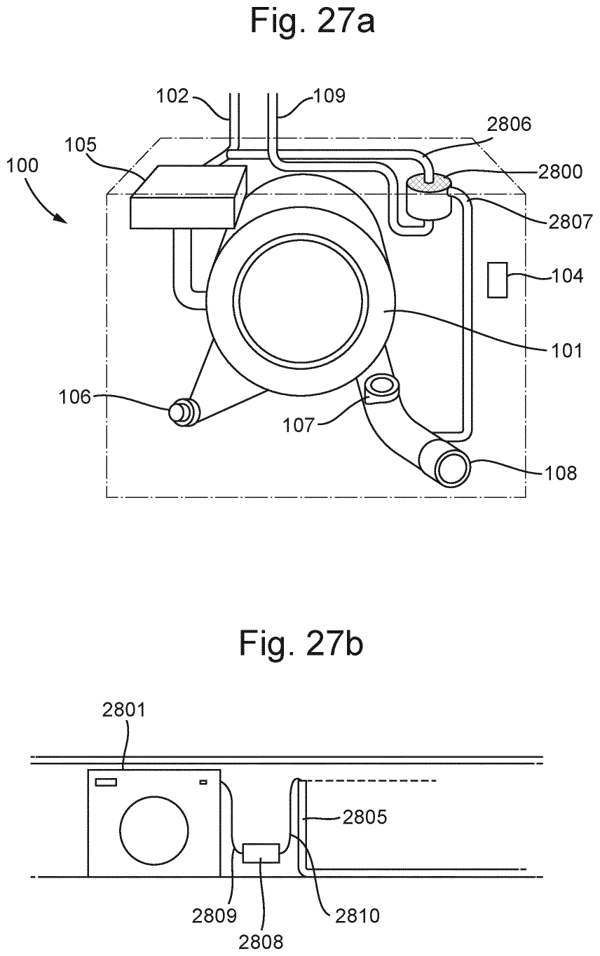

A reservoir 2116 with a fluid level sensor, such as a float switch 2117 may be provided beneath a separator unit, as shown in FIG. 21a. The float switch detects when fluid is present in the reservoir. The float switch is arranged to control the pump 2105 to wash the sieve structure to regenerate the filter pressure. A pressure sensor 1618 may also be provided as shown in FIG. 21b. Alternatively a sensor can be provided at the inlet to detect when effluent is backing up and this can be used to activate the pump to regenerate the filter pressure. The fluid level sensor could be arranged so that it is activated when a particular level of fluid is detected and then activates either the drainage of the separator or pressure regeneration apparatus or both. Alternatively, the fluid level sensor could be graduated so that it determines the level of fluid in the reservoir and the drainage is activated at a given level and the regeneration is activated at a different fluid level.

A bypass system 2200 may be provided to connect the inlet 2201 to the outlet 2204, as shown in FIG. 22. It ensures that if the separator gets blocked or the regeneration system fails for some reason, the entire wash load of effluent will not back up and cause a flood but be diverted to the waste outlet.

FIG. 23 shows an embodiment of a separator unit having a bypass feature for allowing effluent to go around the filter if it becomes clogged. The separator unit has an effluent inlet 2301, a housing 2302 supporting a sieve structure 2303 and an outlet 2304. A bypass conduit 2305 links the inlet 2301 to the outlet 2303. A pressure-activated valve 2306 is located in the conduit 2305. The pressure-activated valve opens when the pressure at the inlet exceeds a certain pre-set value. Therefore, if effluent backs up at the inlet because the filter is clogged, the valve will open and let effluent through to the outlet where it can safely discharge to a waste pipe. Alternatively, the valve 1106 may be of a type that can be electronically controlled. A pressure sensor that detects a pressure differential between the two sides of the sieve structure can control the valve, so that if the pressure differential reaches a predetermined level, the valve is operated and the bypass activated.

FIG. 24 shows another embodiment with an alternative bypass system, where an upstanding tube 2404 links the inlet 2401 to the outlet 2402 of a separator unit 2403. The height “H” of the tube determines the pressure at which the bypass operates. A disadvantage of this system is that a significant height is required above the separator unit to fit the tube 2404, which can be a problem when a washing machine is located in a confined space.

FIG. 25 shows another embodiment with a further alternative bypass system, with a lower profile for fitting in confined spaces. The system comprises a pair of upstanding tubes 2501a, 2501b that link the inlet 2502 to the outlet 2503 of a separator unit 2504. The tubes are connected by chamber 2505. The first upstanding tube 2501a empties effluent into the top of the chamber 2505 at height “H”. When effluent reaches the height “H” of the second tube 2501b it will pass through to the outlet 2503. This arrangement creates an anti-syphon and means that filtered effluent must have sufficient pressure to reach 2×H.

The above embodiments work by creating an obstruction to the flow of the effluent. This may be undesirable from the point of view of washing machine manufacturers who often stipulate that anything connected to the outlet of their machines must not cause an obstruction. FIGS. 26 and 27 show a bypass system that uses the pressure of the flow of the incoming effluent to maintain an obstruction until the lowering flow rate associated with a blockage decreases. FIG. 26 is a bypass system that comprises a Pitot tube in the outlet 2602 from a separator 2603. The Pitot tube is connected to the inlet 2604 of the separator 2603. While the filtered effluent is flowing out of the outlet into the Pitot tube the pressure is enough to prevent the fluid from bypassing the separator from the inlet to the outlet. When filtered effluent stops flowing out of the outlet because of a blockage in the separator, there will be no reverse pressure in the Pitot tube and the effluent will be free to flow directly from the outlet to the inlet.

FIG. 27 shows a further embodiment that uses the Venturi effect to operate a bypass system. A tube 2701 connects to the inlet 2702 of a separator 2703. A restriction 2704 is provided in the tube 2701. A conduit 2705 is provided between the restriction and the outlet 2705 of the separator 2703. When the separator is operating normally, the unfiltered effluent flowing through the restriction 2704 to the inlet will have a lower pressure than the filtered effluent flowing out of the outlet, so the bypass will not operate. If the separator blocks and filtered effluent stops flowing out of the outlet then the pressure against the inlet will drop and the bypass will operate.

The separator system 2800 described above may be installed within a washing machine, as shown in FIG. 28a. The separator system 2400 may be located outside a washing machine, connected to the waste water outlet of the washing machine, as shown in FIG. 28b.

A separator may be provided where the inlet feeds the interior of the sieve structure and the outlet collects filtered effluent from the outside of the sieve structure.

The separator housing may be opened to empty the trap when the effluent has been drained.

An opening at the top of the sieve structure may be provided to avoid air locks.

An air inlet may be provided at the inlet of the separator to avoid syphoning all of the waste water out of a washing machine.

As an alternative to regenerating the pressure of the separator unit, a disposable cartridge may be provided. The part of the separator that contains the filtering element, i.e. the sieve structure, could be provided as a cartridge, that is removed and disposed of and replaced with a new one. Alternatively, the cartridge could be sent for cleaning and then re-used.

Wastewater expelled from textile factories is contaminated with microfibres and it is not guaranteed it will be filtered at municipal facilities. When these facilities exist, they may remove up to 98% of microplastics, however what escapes still equates to millions of microfibres every day. Microfibres removed from water may then be passed to the environment as “sewage sludge”, spread on agricultural land as fertiliser. Ultimately microfibres are passed as pollutants into the natural environment—they need to be stopped at source.

Wet-processing factories currently operate in a linear system, whereby microfibre resources are expelled as pollutants from the technical process into the biological environment. Use of the separator system described herein closes the loop into a continued cycle to retain the value of the microfibres within the technical process and stop damage to the biological environment.

An embodiment of the separator system can be retrofitted onto the existing wastewater outlet of wet-processing textile factories to enable microfibre capture at source before pollution of the natural environment can occur.

The separator system can be used to filter microplastics and other micropollutants from environmental drainage systems, such as roadside gullies. A lot of microplastics in the environment break down from larger items of plastic such as car tires, road surfaces and road markings. After synthetic textiles, tires are the largest source of microplastics and contain harmful materials such as mineral oils.

Catalytic converters are fitted on most cars and contain highly valuable materials such as platinum, palladium, copper and zinc. During use, small amounts of these metals are lost from cars and fragments are deposited on the road surface. While metal concentrations vary geographically, collection and recycling of these materials not only reduces environmental pollution but can also be a revenue stream in a circular economy.

A larger-scale embodiment of the invention can be applied to the treatment of effluent in Wastewater Treatment Plants. For example, the chamber of the separator could be 1 meter in diameter or 2 meters or greater.

Typical sewage networks are built along one of two designs:
i) Combined sewers. These collect surface water and sewage together, meaning all waste water passes through a Wastewater Treatment Plant (WWTP). During heavy rainfall, it is common for sewers to overflow, releasing untreated sewage and pollution into waterbodies.
ii) Separate sewers. These discharge surface water directly into waterbodies.

In both systems, roadside runoff, i.e. surface water from the roads, is released into the environment.

Most roadside gullies have drains located at regular points and these drains have a sediment “pot”, which lets heavy materials like gravel and sand settle to prevent blockage. These hold some micropollutants, but the majority of microplastics and valuable metals are too small and are not retained.

An embodiment of the separation system of the present invention can be retrofitted as an insert into the sediment pot of a drain to filter micropollutants at source. It is designed to fit existing gullies and to be emptied using a mobile vacuum pump.

1-15. (canceled)

16. A separator suitable for separating solid material from a fluid, the separator comprising:
a chamber with an inlet and an outlet,
a sieve structure forming a permeable barrier between the inlet and the outlet to filter the fluid,
and a pump in fluid communication with the chamber, wherein the separator further comprises a filter pressure regeneration apparatus for dislodging filtered material from the sieve structure,
wherein the filter pressure regeneration apparatus comprises a conduit and a nozzle assembly having at least one cleaning jet directed towards the outlet side of the sieve structure and wherein the pump is arranged to recirculate the filtered fluid to the conduit of the filter pressure regeneration apparatus,
wherein the sieve structure has a circular cross-section, and wherein a channel is formed between the chamber and the sieve structure such that in use the fluid is guided circumferentially around the sieve structure through the channel.

17. The separator of claim 16, wherein the pump is a water pump arranged to also drain the separator or a separate pump is provided to drain the separator.

18. The separator of claim 16, wherein a restriction is provided in a conduit downstream from the pump, wherein the aperture of the restriction is set to ensure that a preset amount of filtered fluid is recirculated into the filter pressure regeneration apparatus and an amount of the filtered fluid is drained.

19. The separator of claim 16, wherein an air vent is provided in a conduit between the pump and the filter pressure regeneration apparatus to introduce air into the conduit.

20. The separator of claim 16, wherein the separator further comprises an air pump located between the pump and the filter pressure regeneration apparatus to introduce air into the conduit and to drain the separator.

21. The separator of claim 16, wherein the pump is a positive displacement pump

22. The separator of claim 16, wherein the pump is a centrifugal pump.

23. The separator of claim 16, wherein the nozzle assembly comprises a plurality of cleaning nozzles that are rotatable around the central axis of the sieve structure.

24. The separator of claim 16, wherein the nozzle assembly is rotated by propulsion nozzles arranged to direct a stream of fluid having a vector that is tangential to the circumference of the sieve structure.

25. The separator of claim 16, wherein a sensor is provided, and wherein the filter pressure regeneration apparatus is arranged to be activated in accordance with the output from the sensor.

26. The separator of claim 16, wherein a bypass conduit is provided between the inlet and the outlet to provide an alternative route for fluid in the event that the flow of fluid is impeded.

27. A washing machine with a separator as claimed in claim 16.

28. A method of operating a separator as claimed in claim 16, comprising the steps of;
filtering fluid through a sieve structure,
operating a pump to pressurise the filtered fluid.

29. The method of claim 28, wherein the pump is operated to drain the separator.

30. The method of claim 28, wherein the pump is operated to recirculate the filtered fluid to a pressure regeneration apparatus that is arranged to spray the filtered side of the sieve structure with cleaning fluid to dislodge debris from the unfiltered side of the sieve structure.
